(19) United States
(12) Patent Application Publication
(10) Pub. No.: US 2026/0050746 A1
(43) Pub. Date: Feb. 19, 2026

(54) MESSAGE PROCESSING

(71) Applicant: Beijing Zitiao Network Technology Co., Ltd., Beijing (CN)

(72) Inventors: Hanqing LIU, Beijing (CN); Huangjun SHI, Beijing (CN); Yaohui WANG, Beijing (CN); Yiyu HE, Beijing (CN)

(21) Appl. No.: 19/302,703

(22) Filed: Aug. 18, 2025

(30) Foreign Application Priority Data
Aug. 18, 2024 (CN) 202411133039.0

(51) Int. Cl. G06F 40/35; G06F 9/451

(52) U.S. Cl. CPC G06F 40/35; G06F 9/451

(57) ABSTRACT

A method, an apparatus, a device and a storage medium for message processing are provided. The method includes: obtaining, from a target interaction channel of a plurality of interaction channels, a first interaction message from a user in a chat between the user and a digital assistant; converting, based on a target data structure corresponding to the target interaction channel, the first interaction message into a second interaction message with a predetermined data structure; and performing, based on the second interaction message, a task indicated by the first interaction message.

### CROSS-REFERENCE

The present application claims priority to Chinese Patent Application No. 202411133039.0, filed on Aug. 18, 2024, and entitled “METHOD, APPARATUS, DEVICE AND STORAGE MEDIUM FOR MESSAGE PROCESSING”, which is incorporated herein by reference in its entirety.

### FIELD

Example embodiments of the present disclosure generally relate to the field of computer, and in particular, to message processing.

### BACKGROUND

With the development of the machine learning technology, the application of the robot (Bot) based on the machine learning model becomes more and more extensive, and the chat between the user and the Bot may occur in multiple scenarios. Besides the work scenario with the instant messaging tool as the core, the user also hopes to integrate the intelligent question-and-answer function of the Bot in the current business system (for example, a work order answering system, a customer relationship management (CRM) system, etc.). At this time, it is expected that the Bot can adapt to different channels without large-scale modification, and at the same time, the consistency of information presentation and interaction strategy of each channel can be realized.

### SUMMARY

In a first aspect of the present disclosure, a message processing method is provided. The method includes: obtaining, from a target interaction channel of a plurality of interaction channels, a first interaction message from a user in a chat between the user and a digital assistant; converting, based on a target data structure corresponding to the target interaction channel, the first interaction message into a second interaction message with a predetermined data structure; and performing, based on the second interaction message, a task indicated by the first interaction message.

In a second aspect of the present disclosure, an apparatus for message processing is provided. The apparatus includes: a message obtaining module configured to obtain, from a target interaction channel of a plurality of interaction channels, a first interaction message from a user in a chat between the user and a digital assistant; a message converting module, configured to convert, based on a target data structure corresponding to the target interaction channel, the first interaction message into a second interaction message with a predetermined data structure; and a task performing module, configured to perform, based on the second interaction message, a task indicated by the first interaction message.

In a third aspect of the present disclosure, an electronic device is provided. The device includes at least one processor; and at least one memory, the at least one memory is coupled to the at least one processor and stores instructions for execution by the at least one processor. The instructions, when executed by the at least one processor, causing the electronic device to perform the method of the first aspect.

In a fourth aspect of the present disclosure, a computer-readable storage medium is provided. The computer-readable storage medium having a computer program stored thereon, the computer program being executable by a processor to implement the method of the first aspect.

It should be understood that the content described in this section is not intended to limit the key features or important features of the embodiments of the present disclosure, nor is it intended to limit the scope of the present disclosure. Other features of the present disclosure will become easily understandable through the following description.

### BRIEF DESCRIPTION OF THE DRAWINGS

The above and other features, advantages and aspects of the embodiments of the present disclosure will become more apparent when taken in conjunction with the drawings and with reference to the following detailed description. In the drawings, the same or similar reference numerals refer to the same or similar elements, where:

FIG. 1 is a schematic diagram illustrating an example environment in which the embodiments of the present disclosure can be implemented;

FIG. 2 is a schematic diagram illustrating an architecture for processing a message according to some embodiments of the present disclosure;

FIG. 3 is a schematic diagram illustrating multi-round chat management according to some embodiments of the present disclosure;

FIG. 4 is a flowchart illustrating a process for message processing according to some embodiments of the present disclosure;

FIG. 5 is a schematic structural block diagram illustrating an apparatus for message processing according to some embodiments of the present disclosure; and

FIG. 6 is a block diagram illustrating an electronic device which can implement one or more embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure can be implemented in various forms and should not be interpreted as being limited to the embodiments set forth herein. On the contrary, these embodiments are provided for a more thorough and complete understanding of the present disclosure. It should be understood that the drawings and the embodiments of the present disclosure are only for illustrative purposes and are not intended to limit the protection scope of the present disclosure.

In the description of the embodiments of the present disclosure, the term “include/comprise” and similar expressions should be understood as open inclusion, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may be included below.

In this document, unless explicitly stated, performing a step “in response to A” does not mean that the step is performed immediately after “A”, but may include one or more intermediate steps.

It can be understood that the data involved in the technical solution (including but not limited to the data itself, the acquisition, use, storage or deletion of the data) should comply with the requirements of the corresponding laws, regulations and relevant provisions.

It can be understood that before using the technical solutions disclosed in the embodiments of the present disclosure, relevant users should be informed of the type, use scope, use scenario, etc. of the information involved in the present disclosure and authorization of the relevant users should be obtained through appropriate means according to relevant laws and regulations, where the relevant users may include any type of right subject, for example, individuals, enterprises, groups.

For example, in response to receiving an active request from the user, prompt information is sent to the relevant user to explicitly prompt the relevant user that the operation requested to be performed will require the acquisition and use of the information of the relevant user, so that the relevant user can independently select whether to provide information to software or hardware such as an electronic device, an application, a server or a storage medium that performs the operation of the technical solution of the present disclosure according to the prompt information.

As an optional but non-restrictive implementation, the manner of sending the prompt information to the relevant user in response to receiving the active request from the relevant user may be, for example, a pop-up window, and the prompt information may be presented in the form of text in the pop-up window. In addition, the pop-up window may also carry a selection control for the user to select “agree” or “disagree” to provide information to the electronic device.

It can be understood that the above process of notifying and obtaining user authorization is only schematic, and does not constitute a limitation on the implementation of the present disclosure. Other manners that satisfy relevant laws and regulations may also be applied to the implementation of the present disclosure.

As used herein, the term “model” can learn the association between corresponding inputs and outputs from training data, so that after the training is completed, corresponding outputs can be generated for given inputs. The generation of the model may be based on a machine learning technology. Deep learning is a machine learning algorithm that processes input and provides corresponding output by using multiple processing units. A neural network model is an example of a model based on deep learning. In this document, “model” may also be referred to as “machine learning model”, “learning model”, “machine learning network” or “learning network”, and these terms are used interchangeably herein.

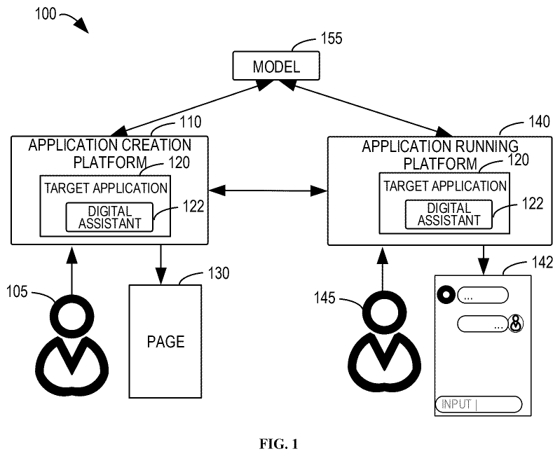

FIG. 1 shows a schematic diagram illustrating an example environment 100 in which the embodiments of the present disclosure can be implemented. The environment 100 relates to an application creation platform 110 and an application running platform 140.

As shown in FIG. 1, the application creation platform 110 may provide a creation and release environment of an application for a user 105. The user 105 may be referred to as an application creation user or a creator. In some embodiments, the application creation platform 110 may be a low-code platform, which provides a set of tools for application creation. The application creation platform 110 can support visual development of various types of applications, so that developers may skip the process of manual coding and accelerate the development cycle and cost of the application. The application creation platform 110 may support any suitable platform for the user to develop one or more types of applications, for example, it may include a platform based on application platform as a service (aPaaS). Such a platform can support the user to efficiently develop the application and realize operations such as application creation and application function adjustment.

The application creation platform 110 may be deployed locally on the terminal device of the user 105 and/or may be supported by a server device. For example, the terminal device of the user 105 may run a client having the application creation platform 110, and the client may support the interaction between the user and the application creation platform 110 provided by the server-side. In the case that the application creation platform 110 runs locally on the terminal device of the user, the user 105 can directly use the terminal device to interact with the local application creation platform 110. In the case that the application creation platform 110 runs on the server device, the server device can realize service provision for the client running on the terminal device based on a communication connection with the terminal device. The application creation platform 110 may present a corresponding page 130 to the user 105 based on an operation of the user 105, in order to output information related to application creation to the user 105 and/or receive the information related to application creation from the user 105.

In some embodiments, the application creation platform 110 may be associated with a corresponding database, which stores data or information required for the application creation process supported by the application creation platform 110. For example, the database may store codes and description information corresponding to respective functional modules for composing the application. The application creation platform 110 may also perform operations such as invoking, adding, deleting, and updating on the functional modules in the database. The database may also store operations executable on different functional blocks. For example, in a scenario where an application is to be created, the application creation platform 110 may invoke a corresponding functional block from the database to build the application.

In the embodiment of the present disclosure, the user 105 may create a target application 120 as needed on the application creation platform 110 and publish the target application 120. The target application 120 may be published to any suitable application running platform 140 as long as the application running platform 140 can support the running of the target application 120. After being published, the target application 120 may be configured to operated by one or more users 145. The user 145 may be referred to as a terminal user of the target application 120. In some embodiments, the target application 120 may include or be implemented as a digital assistant 122.

The digital assistant 122 may be configured to have an intelligent conversation. In the example shown in FIG. 1, the digital assistant 122 may be integrated into the target application 120 to assist in performing task processing within the target application 120 as a part of the target application 120. In other examples, the digital assistant 122 may be configured as an application that runs independently, for example, a web application or other types of applications. In such an example, the digital assistant 122 and the target application 120 may be regarded as the same application. The digital assistant 122 is provided to assist the user in various task processing requirements in different applications and scenarios. In the process of interacting with the digital assistant 122, the user inputs an interaction message, and the digital assistant 122 provides a reply message in response to the user input. Generally, the digital assistant 122 can support the user to input a question in a natural language and perform a task and provide a reply based on the understanding of the natural language input and logical reasoning ability.

In some embodiments, the digital assistant 122 may interact with the user 145 as a contact of the user 145. For example, the digital assistant 122 may be implemented in an instant messaging (IM) application. The digital assistant 122 may interact with the user 145 in a single chat with the user 145. In some embodiments, the digital assistant 122 may interact with a plurality of users in a group chat including a plurality of users.

For each user 145, a client of the application running platform 140 may present an interaction window 142 of the target application 120 or the digital assistant 122, such as a chat window with the digital assistant 122, in a client interface. The user 145 may input a chat message in the chat window, and the target application 120 may determine a reply message of the digital assistant 122 based on the created configuration information and present it to the user in the interaction window 142. In some embodiments, depending on the configuration of the target application 120, the interaction message with the target application 120 may include messages in multimodal forms, such as text messages (for example, natural language texts), speech messages, image messages, video messages, and so on.

Similar to the application creation platform 110, the application running platform 140 may be deployed locally on the terminal device of each user 145 and/or may be supported by a server device. For example, the terminal device of the user 145 may run a client having the application running platform 140, and the client can support the interaction between the user and the application running platform 140 provided by the server. In the case that the application running platform 140 runs locally on the terminal device of the user, the user 145 may directly use the terminal device to interact with the local application running platform 140. In the case that the application running platform 140 runs on the server device, the server device may realize service provision for the client running on the terminal device based on a communication connection with the terminal device. The application running platform 140 may present a corresponding application page to the user 145 based on an operation of the user 145, to output information related to application use to the user 145 and/or receive the information related to application use from the user 145.

In some embodiments, the implementation of at least part of the functions of the target application 120 and/or the implementation of at least part of the functions of the digital assistant 122 in the target application 120 may be implemented based on a model. In the process of creating or running the target application 120, one or more models 155, such as capabilities of the models 155, may be invoked. In the target application 120, the digital assistant 122 may use the model 155 to understand the user input and provide a reply to the user based on the output of the model 155.

In the creation process, the application creation platform 110 needs to use the model 155 to test the target application 120 to determine that the running result of the target application 120 meets expectations. In the running process, in response to different operation requests from the user of the target application 120, the application running platform 140 may need to use the model 155 to determine the response result to the user.

Although illustrated as being independent of the application creation platform 110 and the application running platform 140, one or more models 155 may run on the application creation platform 110 and/or the application running platform 140, or other remote servers. In some embodiments, the model 155 may be a machine learning model, a deep learning model, a learning model, a neural network, and so on. In some embodiments, the model may be based on a language model (LM). The language model can have a question answering ability by learning from a large amount of corpus. The model 155 may also be based on other suitable models.

The application creation platform 110 and/or the application running platform 140 may run on a suitable electronic device. The electronic device here may be any type of device with computing capabilities, including a terminal device or a server device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. The server device may include, for example, a computing system/server, such as a mainframe, an edge computing node, a computing device in a cloud environment, and so on. In some embodiments, the application creation platform 110 and/or the application running platform 140 may be implemented based on cloud services.

It should be understood that the structure and function of the environment 100 are described for illustrative purposes only and without implying any limitation to the scope of the present disclosure. For example, although FIG. 1 illustrates a single user interacting with the application creation platform 110 and a single user interacting with the application running platform 140, a plurality of users may actually access the application creation platform 110 to create digital assistants respectively, and each digital assistant may be used to interact with a plurality of users.

As mentioned above, the Bot has certain defects in multi-channel interaction. In addition, Bot interaction mainly depends on a single-round of text question-and-answer mode, which has great limitations in dealing with complex interaction scenarios (such as follow-up clarification, visual forms, multimodal message display, etc.).

To this end, a solution for message processing is provided according to the embodiments of the present disclosure. According to various embodiments of the present disclosure, a first interaction message from a user in a chat between a user and a digital assistant is obtained from a target interaction channel of a plurality of interaction channels. The first interaction message is converted into a second interaction message with a predetermined data structure based on a target data structure corresponding to the target interaction channel. A task indicated by the first interaction message is performed based on the second interaction message.

In various embodiments of the present disclosure, the first interaction message obtained from different interaction channels is converted into the second interaction message with the predetermined data structure, which ensures the consistency of messages transmitted on different interaction channels. In this manner, the user may interact with the digital assistant through different interaction channels, which improves the scalability of the interaction mode. Therefore, the interaction experience of the user with the digital assistant can be improved.

The example embodiments of the present disclosure will be described below with continued reference to the drawings. In the following examples, for the sake of discussion, it is described from the perspective of the application running platform, such as the application running platform 140 shown in FIG. 1. The page presented by the application running platform 140 may be presented via the terminal device of the user 145, and the user input may be received via the terminal device of the user 145.

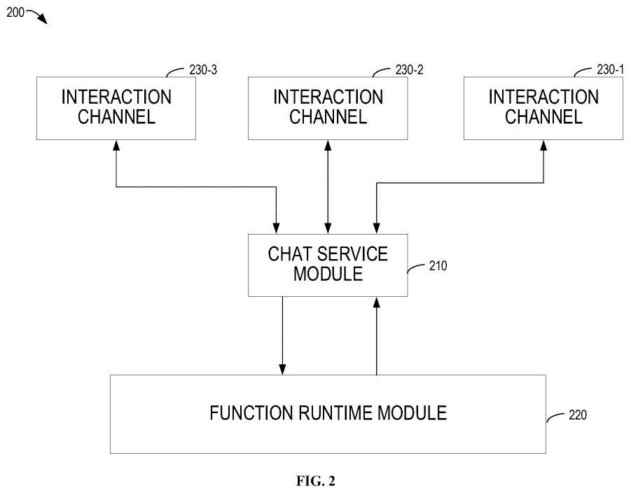

FIG. 2 shows a schematic diagram illustrating an architecture 200 for processing a message according to some embodiments of the present disclosure. As shown in FIG. 2, a chat service module 210 and a function runtime module 220 may be deployed in the application running platform 140 to reply to the requests of the user 145. The function runtime module 220 may implement at least one function of the digital assistant, such as a question-and-answer function, a personalized recommendation function, and so on.

The chat service module 210 may provide and support different interaction channels between the user and the digital assistant, such as interaction channels 230-1, 230-2, 230-3, which may also be collectively or individually referred to as the interaction channel 230. It should be understood that the number of interaction channels shown in FIG. 2 is only illustrative and is not intended to limit the scope of the present disclosure.

In some embodiments, the digital assistant can be triggered for interaction in a plurality of interaction channels. These interaction channels have respective message presentation modes and support respective computer languages. For example, these interaction channels may use different message protocols or have custom message formats. In some embodiments, the respective message presentation modes of these interaction channels may be based on the respective chat user interface (CUI) capabilities of these interaction channels.

The interaction channel may refer to an interaction form, an interaction mode, and an interaction interface between the user and the digital assistant. For example, the interaction channel may be an interaction via an instant messaging (IM) application or component. In such interaction, interaction messages between the user and the digital assistant are usually presented in the form of messages. For another example, the interaction channel may be an interaction via a web interface, and in such interaction, it may support presenting interaction messages between the user and the digital assistant in a rich media form. For another example, for the interaction via the IM application or component, there may also be different interaction channels, for example, one interaction channel supports text-type interaction messages, while another channel may indicate messages in the form of cards. The messages in the form of cards may not only display texts, but also display other forms of content, such as charts, forms, etc.

In the interaction between the user and the digital assistant, the application running platform 140 may obtain a first interaction message from the user in a chat between the user and the digital assistant from a target interaction channel of the plurality of interaction channels 230. For example, the first interaction message may come from a chat window of an IM application.

In some embodiments, the plurality of interaction channels 230 may include a chat application deployed with the digital assistant. The digital assistant may be directly published in the chat application to implement the digital assistant function. For example, the user may send the interaction message to the digital assistant through a chat window associated with the digital assistant in the chat application. It should be understood that the chat application may be an application including a chat function, and such application may also provide other functions or business components, such as email, calendar, document, etc.

Alternatively or additionally, the plurality of interaction channels 230 may include a web application embedded with the digital assistant. In an example, a software development kit (SDK) related to the digital assistant may be provided to the web application, and then the web application may implement the digital assistant function by integrating this SDK. The SDK includes a pre-compiled codebase, documents, example code and tools. By providing the SDK to the web application, the development efficiency can be improved and the function expansion of the web application can be realized.

Alternatively or additionally, the plurality of interaction channels 230 may include an application programming interface (API) for docking with the digital assistant. In an example, the third-party application may send the interaction message to the digital assistant by invoking the API. For example, the user may input the interaction message in the input window of the third-party application, and then the third-party application may send the interaction message to the digital assistant by invoking the application programming interface.

After obtaining the first interaction message, the application running platform 140 may convert the first interaction message into a second interaction message with a predetermined data structure based on a target data structure corresponding to the target interaction channel. Since the target interaction channel and the application running platform 140 may use different programming languages, frameworks or platforms, and their respective supported data formats are different, it is necessary to convert the interaction messages obtained from different interaction channels into interaction messages with a predetermined data structure, so that the application running platform 140 may process the interaction messages with the predetermined data structure. For example, such a predetermined data structure may be defined by a structured message protocol to simultaneously support multi-channel parsing adaptation capabilities. In addition, the protocol should have good scalability so that future functions and requirements can be integrated seamlessly. The protocol ensures that the messages generated by the digital assistant on different channels are consistent and unambiguous.

In some embodiments, the target data structure may include a standardized data structure used by the target interaction channel. The standardized data structure means that any interaction channel can use the same standardized data structure to have a chat with the digital assistant. In an example, the standardized data structure may include a data structure specified in an application programming interface.

Alternatively or additionally, the target data structure may include a data structure specific to the target interaction channel. For different interaction channels, it is necessary to consider the characteristics of different interaction channels, and therefore the data structures specific to different interaction channels are different. For example, if the first interaction channel is a chat application and the second interaction channel is a web application, due to the differences in functional characteristics, implementation manners, etc. between the first interaction channel and the second interaction channel, the data structure specific to the first interaction channel is different from the data structure specific to the second interaction channel. For another example, the interaction channel may use a custom protocol or data format.

After obtaining the second interaction message with the predetermined data structure, the application running platform 140 may perform the task indicated by the first interaction message based on the second interaction message. In an example, the application running platform 140 may send a processing result obtained by performing the task to the corresponding interaction channel.

In some embodiments, in response to presence of at least one first historical interaction message from the target interaction channel before the first interaction message is obtained, the application running platform 140 may determine at least one second historical interaction message with the predetermined data structure. The at least one second historical interaction message is obtained by performing data structure conversion on the at least one first historical interaction message. The first historical interaction message has the target data structure, and the second historical interaction message has the predetermined data structure. If there is at least one first historical interaction message before the first interaction message, it means that the application running platform 140 needs to manage a multi-round chat. In an example, the application running platform 140 may extract at least one second historical interaction message from a historical message flow.

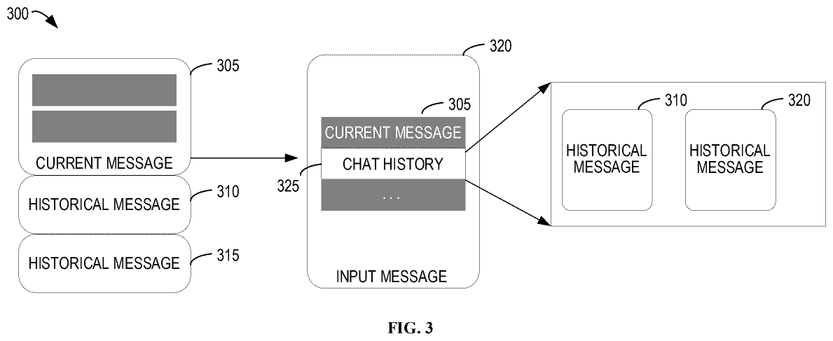

In some embodiments, the second interaction message and the at least one second historical interaction message may be input into the function runtime module 120 for task processing according to the multi-round chat. FIG. 3 shows a schematic diagram 300 illustrating multi-round chat management according to some embodiments of the present disclosure. As shown in FIG. 3, a historical message 310 and a historical message 315 occur before a current message 305 (as an example of the second interaction message). The current message 305 and a chat history 325 may be placed in an input message 320 so that the function runtime module 120 performs task processing based on the input message 320. The historical message 310 and the historical message 315 are stored in the chat history 325.

After obtaining the at least one second historical interaction message, the application running platform 140 may perform the task based on the second interaction message and the at least one second historical interaction message. In this manner, the digital assistant can understand the complex needs of the user, thereby providing more accurate and comprehensive answers, and may adjust subsequent questions or suggestions according to the answers and feedback of the user, thereby providing a more personalized experience.

In some embodiments, the application running platform 140 may determine a predetermined number of message rounds of semantic information indicating a multi-round chat is carried. For example, if the predetermined number of message rounds is 10 rounds, it means that the 10 rounds of chat carry the semantic information, that is, the influence of the historical messages may be considered in the 10 rounds of chat. After determining the predetermined number of message rounds, the application running platform 140 may obtain at least one second historical interaction message from the stored historical interaction messages based on the predetermined number of message rounds, where the number of the at least one second historical interaction message is related to the predetermined number of message rounds. In one example, the number of the at least one second historical interaction message is positively correlated with the predetermined number of message rounds, and the more the predetermined number of message rounds, the more the number of the at least one second historical interaction message. For example, if the current chat is the 15th round of chat, 10 rounds of chat before the 15th round of chat may be obtained as the at least one second historical interaction message.

In some embodiments, based on the execution result of the task, a third interaction message with the predetermined data structure may be generated as a response to the first interaction message. Since the task is performed in the application running platform 140, a response message (that is, the third interaction message) with the predetermined data structure may be generated. After obtaining the third interaction message, the application running platform 140 may convert the third interaction message into a fourth interaction message with the target data structure. Since the target interaction channel supports the target data structure, it is necessary to transform the data structure of the response message to obtain the fourth interaction message with the target data structure. After that, the application running platform 140 may provide the fourth interaction message to the target interaction channel, thereby providing a response to the user.

In some embodiments, the application running platform 140 may determine a processing mode for a predetermined type of content included in the first interaction message. For example, the processing mode may include extracting pictures, processing quoted messages, processing information with a mentioned person, or processing and converting data in charts (for example, filtering and sorting, row-column conversion, etc.).

After determining the processing mode, the application running platform 140 may process the content of the predetermined type in the second interaction message based on the determined processing mode and the predetermined data structure for performing the task. In the scenario of multi-round chat, the application running platform 140 may place the result obtained by performing the task in each round in the prompt information of the machine learning model used by the digital assistant, so that the machine learning model can fully consider the contextual information and ensure the accurate understanding of the user's intention.

In some embodiments, the content of the predetermined type includes at least one of: an image, a quoted message, information with a mentioned person, or a chart. In an example, the quoted message may include a message quoted by a uniform resource locator (URL). In an example, the information with a mentioned person may include information mentioning a person by using an “@” symbol. In this manner, effective clarification, selection, and correction are performed in the multi-round chat to ensure accurate understanding of intention of the users.

In some embodiments, after obtaining the second interaction message, the application running platform 140 may route the second interaction message to the corresponding service module according to the service type requested by the first interaction message. In one example, the digital assistant may provide services of different types, and the service modules corresponding to these services may be deployed separately. For example, the service requested by the first interaction message is a question-and-answer service, so that the application running platform 140 may route the second interaction message to a question-and-answer service module corresponding to the question-and-answer service. In this manner, the interaction channel may obtain the corresponding service response by sending a unified service request without considering the deployment location of different service modules, and may decouple the interaction channel from the services provided by the digital assistant, the flexibility of the interaction between the user and the digital assistant is improved.

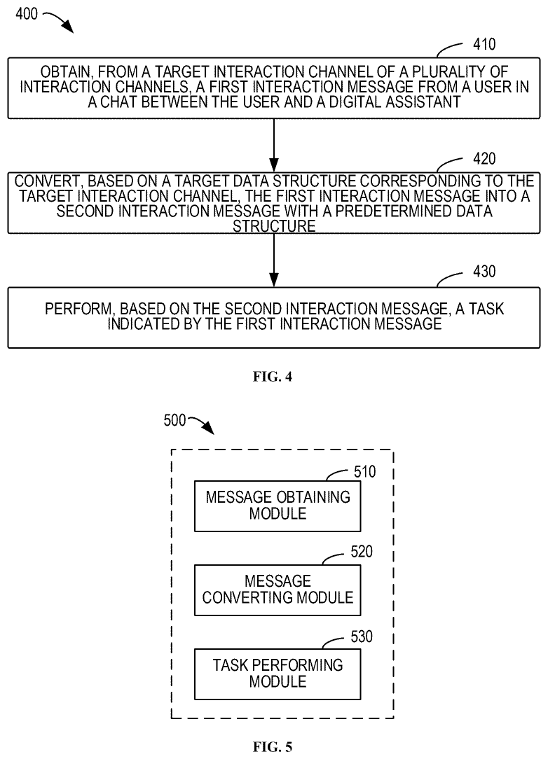

FIG. 4 is a flowchart illustrating a process 400 for message processing according to some embodiments of the present disclosure. The process 400 may be implemented at the application running platform 140. The process 400 will be described below with reference to FIG. 4.

At block 410, the application running platform 140 obtains, from a target interaction channel of a plurality of interaction channels, a first interaction message from a user in a chat between the user and a digital assistant.

At block 420, the application running platform 140 converts, based on a target data structure corresponding to the target interaction channel, the first interaction message into a second interaction message with a predetermined data structure.

At block 430, the application running platform 140 performs, based on the second interaction message, a task indicated by the first interaction message.

In some embodiments, the process 400 further includes: generating, based on a result of performing the task, a third interaction message with the predetermined data structure as a response to the first interaction message; converting the third interaction message into a fourth interaction message with the target data structure; and providing the fourth interaction message to the target interaction channel.

In some embodiments, performing the task includes: determining, in response to presence of at least one first historical interaction message from the target interaction channel before the first interaction message is obtained, at least one second historical interaction message with the predetermined data structure, the at least one second historical interaction message obtained by performing data structure conversion on the at least one first historical interaction message, and wherein the first historical interaction message has the target data structure; and performing the task based on the second interaction message and the at least one second historical interaction message.

In some embodiments, the process 400 further includes: determining a predetermined number of message rounds of semantic information indicating a multi-round chat is carried; and obtaining, based on the predetermined number of message rounds, the at least one second historical interaction message from stored historical interaction messages, wherein a number of the at least one second historical interaction message is related to the predetermined number of message rounds.

In some embodiments, the process 400 further includes: determining a processing mode for content of a predetermined type included in the first interaction message; and processing, based on the determined processing mode and the predetermined data structure, content of the predetermined type in the second interaction message for performing the task.

In some embodiments, the content of the predetermined type includes at least one of: an image, a quoted message, information with a mentioned person, or a chart.

In some embodiments, the target data structure includes a standardized data structure used by the target interaction channel or a data structure specific to the target interaction channel.

In some embodiments, the plurality of interaction channels include at least two of: a chat application deployed with the digital assistant, a web application embedded with the digital assistant, or an application programming interface for docking with the digital assistant.

FIG. 5 is a schematic structural block diagram illustrating an apparatus 500 for message processing according to some embodiments of the present disclosure. The apparatus 500 may be implemented in or included in the application running platform 140, for example. Respective modules/components in the apparatus 500 may be implemented by hardware, software, firmware or any combination thereof.

As shown, the apparatus 500 includes a message obtaining module 510 configured to obtain, from a target interaction channel of a plurality of interaction channels, a first interaction message from a user in a chat between the user and a digital assistant.

The apparatus 500 also includes a message converting module 520 configured to convert, based on a target data structure corresponding to the target interaction channel, the first interaction message into a second interaction message with a predetermined data structure. The apparatus 500 also includes a task performing module 530 configured to perform, based on the second interaction message, a task indicated by the first interaction message.

In some embodiments, the apparatus 500 also includes a service response module 530, configured to: generate, based on a result of performing the task, a third interaction message with the predetermined data structure as a response to the first interaction message; convert the third interaction message into a fourth interaction message with the target data structure; and provide the fourth interaction message to the target interaction channel.

In some embodiments, the task performing module 530 is further configured to determine, in response to presence of at least one first historical interaction message from the target interaction channel before the first interaction message is obtained, at least one second historical interaction message with the predetermined data structure, the at least one second historical interaction message obtained by performing data structure conversion on the at least one first historical interaction message, and wherein the first historical interaction message has the target data structure; and perform the task based on the second interaction message and the at least one second historical interaction message.

In some embodiments, the apparatus 500 also includes a second task processing module, configured to determine a processing mode for a predetermined type of content included in the first interaction message; and process, based on the determined processing mode and the predetermined data structure, the content of the predetermined type in the second interaction message for performing the task.

In some embodiments, the apparatus 500 further includes a second historical interaction message acquiring module, configured to determine a predetermined number of message rounds of semantic information indicating a multi-round chat is carried; and obtain, based on the predetermined number of message rounds, the at least one second historical interaction message from stored historical interaction messages, wherein a number of the at least one second historical interaction message is related to the predetermined number of message rounds.

In some embodiments, the content of the predetermined type includes at least one of: an image, a quoted message, information with a mentioned person, or a chart.

In some embodiments, the target data structure includes a standardized data structure used by the target interaction channel or a data structure specific to the target interaction channel.

In some embodiments, the plurality of interaction channels include at least two of: a chat application deployed with the digital assistant, a web application embedded with the digital assistant, or an application programming interface for docking with the digital assistant.

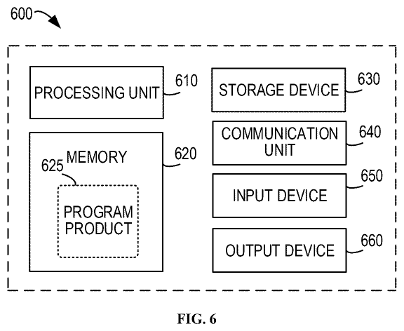

FIG. 6 is a block diagram illustrating an electronic device 600 which can implement one or more embodiments of the present disclosure. It should be understood that the electronic device 600 shown in FIG. 6 is only illustrative and should not constitute any limitation to the functions and scope of the embodiments described herein. The electronic device 600 shown in FIG. 6 may include or be implemented as the application running platform 140 in FIG. 1 or the apparatus 500 in FIG. 5.

As shown in FIG. 6, the electronic device 600 is in the form of a general-purpose electronic device. The components of the electronic device 600 may include but not limited to one or more processors or processing units 610, a memory 620, a storage device 630, one or more communication units 640, one or more input devices 650, and one or more output devices 660. The processing unit 610 may be an actual or virtual processor and can perform various processing according to programs stored in the memory 620. In a multiprocessor system, multiple processing units execute computer-executable instructions in parallel to improve the parallel processing capability of the electronic device 600.

Electronic device 600 typically includes multiple computer storage media. Such media may be any available media accessible to the electronic device 600, including but not limited to volatile and non-volatile media, removable and non-removable media. The memory 620 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 630 may be a removable or non-removable medium, and may include a machine readable medium, such as a flash drive, a magnetic disk, or any other medium, which may be capable of storing information and/or data and may be accessed within the electronic device 600.

The electronic device 600 may further include additional removable/non-removable and volatile/non-volatile storage media. Although not shown in FIG. 6, a magnetic disk drive for reading from or writing to a removable, non-volatile magnetic disk (for example, a “floppy disk”) and an optical disk drive for reading from or writing to a removable, non-volatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 enables communication with other electronic devices through a communication medium. Additionally, the functions of the components of the electronic device 600 may be implemented in a single computing cluster or multiple computing machines that can communicate through communication connections. Therefore, the electronic device 600 can operate in a networked environment using logical connections to one or more other servers, network personal computers (PCs), or another network node.

The input device 650 may be one or more input devices, such as a mouse, a keyboard, a trackball, and so on. The output device 660 may be one or more output devices, such as a display, a speaker, a printer, and so on. The electronic device 600 may also communicate with one or more external devices (not shown), such as storage devices, display devices, etc., communicate with one or more devices that enable users to interact with the electronic device 600, or communicate with any device (for example, a network card, a modem, etc.) that enables the electronic device 600 to communicate with one or more other electronic devices, as needed, through the communication unit 640. Such communication may be performed via an input/output (I/O) interface (not shown).

According to an example implementation of the present disclosure, a computer-readable storage medium is provided, on which computer-executable instructions are stored, where the computer-executable instructions are executed by a processor to implement the above-described method. According to an example implementation of the present disclosure, a computer program product is also provided, the computer program product is tangibly stored on a non-transitory computer-readable medium and includes computer-executable instructions, and the computer-executable instructions are executed by a processor to implement the above-described method.

Various aspects of the present disclosure are described herein with reference to flowcharts and/or block diagrams of the method, apparatus, device and computer program product implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer or other programmable data processing apparatus, thereby producing a machine, such that the instructions, when executed by the processing unit of the computer or the other programmable data processing apparatus, produce an apparatus for implementing the functions/actions specified in one or more blocks of the flowcharts and/or block diagrams. These computer-readable program instructions may also be stored in a computer-readable storage medium, and the instructions cause the computer, the programmable data processing apparatus and/or other devices to work in a specific manner, so that the computer-readable medium storing the instructions includes an article of manufacture, which includes instructions for implementing various aspects of the functions/actions specified in one or more blocks of the flowcharts and/or block diagrams.

The computer-readable program instructions may be loaded onto the computer, other programmable data processing apparatus, or other device, such that a series of operational steps are performed on the computer, other programmable data processing apparatus or other device to produce a computer-implemented process, such that the instructions executed on the computer, other programmable data processing apparatus or other device implement the functions/actions specified in one or more blocks of the flowcharts and/or block diagrams.

The flowcharts and block diagrams in the drawings illustrate the architecture, functionality, and operation of possible implementations of systems, methods and computer program products according to multiple implementations of the present disclosure. In this regard, each block in the flowcharts or block diagrams may represent a module, a program segment, or a portion of instructions, and the module, the program segment, or the portion of instructions contains one or more executable instructions for implementing specified logical functions. In some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by special-purpose hardware-based systems that perform the specified functions or acts, or combinations of special-purpose hardware and computer instructions.

Various implementations of the present disclosure have been described above, and the above description is illustrative, not exhaustive, and is not limited to the disclosed implementations. Many modifications and variations will be apparent to those of ordinary skill in the art without departing from the scope and spirit of the described implementations. The terminology used herein was chosen in order to best explain the principles of the implementations, the practical application or the improvement over the technologies in the market, or to enable others of ordinary skill in the art to understand the implementations disclosed herein.

1. A method of message processing, comprising:
obtaining, from a first interaction channel of a plurality of interaction channels, a first interaction message from a user in a chat between the user and a digital assistant;
converting, based on a first data structure corresponding to the first interaction channel, the first interaction message into a second interaction message with a second data structure; and
performing, based on the second interaction message, a task indicated by the first interaction message.

2. The method of claim 1, further comprising:
generating, based on a result of performing the task, a third interaction message with the second data structure as a response to the first interaction message;
converting the third interaction message into a fourth interaction message with the first data structure; and
providing the fourth interaction message to the first interaction channel.

3. The method of claim 1, wherein performing the task comprises:
determining, in response to presence of at least one first historical interaction message from the first interaction channel before the first interaction message is obtained, at least one second historical interaction message with the second data structure, the at least one second historical interaction message obtained by performing data structure conversion on the at least one first historical interaction message, and wherein the first historical interaction message has the first data structure; and
performing the task based on the second interaction message and the at least one second historical interaction message.

4. The method of claim 3, further comprising:
determining a second number of message rounds of semantic information indicating a multi-round chat is carried; and
obtaining, based on the second number of message rounds, the at least one second historical interaction message from stored historical interaction messages, wherein a number of the at least one second historical interaction message is related to the second number of message rounds.

5. The method of claim 1, further comprising:
determining a processing mode for content of a second type comprised in the first interaction message; and
processing, based on the determined processing mode and the second data structure, content of the second type in the second interaction message for performing the task.

6. The method of claim 5, wherein the content of the second type comprises at least one of:
an image,
a quoted message,
information with a mentioned person, or
a chart.

7. The method of claim 1, wherein the first data structure comprises a standardized data structure used by the first interaction channel or a data structure specific to the first interaction channel.

8. The method of claim 1, wherein the plurality of interaction channels comprise at least two of:
a chat application deployed with the digital assistant,
a web application embedded with the digital assistant, or
an application programming interface for docking with the digital assistant.

9. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
obtaining, from a first interaction channel of a plurality of interaction channels, a first interaction message from a user in a chat between the user and a digital assistant;
converting, based on a first data structure corresponding to the first interaction channel, the first interaction message into a second interaction message with a second data structure; and
performing, based on the second interaction message, a task indicated by the first interaction message.

10. The electronic device of claim 9, wherein the acts further comprise:
generating, based on a result of performing the task, a third interaction message with the second data structure as a response to the first interaction message;
converting the third interaction message into a fourth interaction message with the first data structure; and
providing the fourth interaction message to the first interaction channel.

11. The electronic device of claim 9, wherein performing the task comprises:
determining, in response to presence of at least one first historical interaction message from the first interaction channel before the first interaction message is obtained, at least one second historical interaction message with the second data structure, the at least one second historical interaction message obtained by performing data structure conversion on the at least one first historical interaction message, and wherein the first historical interaction message has the first data structure; and
performing the task based on the second interaction message and the at least one second historical interaction message.

12. The electronic device of claim 11, wherein the acts further comprise:
determining a second number of message rounds of semantic information indicating a multi-round chat is carried; and
obtaining, based on the second number of message rounds, the at least one second historical interaction message from stored historical interaction messages, wherein a number of the at least one second historical interaction message is related to the second number of message rounds.

13. The electronic device of claim 9, wherein the acts further comprise:
determining a processing mode for content of a second type comprised in the first interaction message; and
processing, based on the determined processing mode and the second data structure, content of the second type in the second interaction message for performing the task.

14. The electronic device of claim 13, wherein the content of the second type comprises at least one of:
an image,
a quoted message,
information with a mentioned person, or
a chart.

15. The electronic device of claim 9, wherein the first data structure comprises a standardized data structure used by the first interaction channel or a data structure specific to the first interaction channel.

16. The electronic device of claim 9, wherein the plurality of interaction channels comprise at least two of:
a chat application deployed with the digital assistant,
a web application embedded with the digital assistant, or
an application programming interface for docking with the digital assistant.

17. A non-transitory computer-readable storage medium having a computer program stored thereon, the computer program being executable by a processor to implement acts comprising:
obtaining, from a first interaction channel of a plurality of interaction channels, a first interaction message from a user in a chat between the user and a digital assistant;
converting, based on a first data structure corresponding to the first interaction channel, the first interaction message into a second interaction message with a second data structure; and
performing, based on the second interaction message, a task indicated by the first interaction message.

18. The non-transitory computer-readable storage medium of claim 17, wherein the acts further comprise:
generating, based on a result of performing the task, a third interaction message with the second data structure as a response to the first interaction message;
converting the third interaction message into a fourth interaction message with the first data structure; and
providing the fourth interaction message to the first interaction channel.

19. The non-transitory computer-readable electronic device of claim 17, wherein performing the task comprises:
determining, in response to presence of at least one first historical interaction message from the first interaction channel before the first interaction message is obtained, at least one second historical interaction message with the second data structure, the at least one second historical interaction message obtained by performing data structure conversion on the at least one first historical interaction message, and wherein the first historical interaction message has the first data structure; and
performing the task based on the second interaction message and the at least one second historical interaction message.

20. The electronic device of claim 19, wherein the acts further comprise:
determining a second number of message rounds of semantic information indicating a multi-round chat is carried; and
obtaining, based on the second number of message rounds, the at least one second historical interaction message from stored historical interaction messages, wherein a number of the at least one second historical interaction message is related to the second number of message rounds.
